(19) United States
(12) Patent Application Publication
(10) Pub. No.: US 2025/0297939 A1
(43) Pub. Date: Sep. 25, 2025

(54) AUTOMATED GATE DRAWING IN FLOW CYTOMETRY DATA

(71) Applicant: INVIVOSCRIBE, INC., San Diego, CA (US)

(72) Inventors: Jacob William Charles SILBERG, New York, NY (US); Bradley Arthur PATAY, San Diego, CA (US)

(21) Appl. No.: 18/864,174

(22) PCT Filed: Dec. 12, 2023
(86) PCT No.: PCT/US2023/083706

§ 371 Date: Nov. 8, 2024

Related U.S. Application Data
(60) Provisional application No. 63/435,244, filed on Dec. 24, 2022.

(51) Int. Cl. G01N 15/1429; G01N 15/01; G06N 3/0455

(52) U.S. Cl. CPC G01N 15/1429; G01N 15/01; G06N 3/0455

(57) ABSTRACT

A device receives cell representations produced by a flow cytometry machine from a sample (e.g., blood or bone marrow) of a patient, the cell representations comprising location data and organized in a graph based on the location data, each cell representation corresponding to a cell of the sample. The device inputs the cell representations into a supervised machine learning model, and receives, from the supervised machine learning model, classifications of cell type for each of the cell representations. The device applies an unsupervised machine learning model to the classified cell representations, the unsupervised machine learning model outputting different gates for each of the classifications, the different gates forming an intersection. The device reapplies the unsupervised machine learning model to cell representations within the intersection until the intersection is eliminated.

### CROSS REFERENCE TO RELATED APPLICATION

This application claims priority under 35 U.S.C. § 119(e) to U.S. Provisional Patent Application Ser. No. 63/435,244, “Automated Gate Drawing in Flow Cytometry Data,” filed Dec. 24, 2022. The subject matter of all of the foregoing is incorporated herein by reference in its entirety.

### BACKGROUND

Flow cytometry is a technique used to detect and measure physical and chemical characteristics of a population of cells or particles, and can be used to detect and monitor hematological malignancies. A standard approach to accomplish this is to run a sample (e.g., a blood or bone marrow sample) through a flow cytometry machine which then produces a multi-dimensional measurement for each cell in the sample. The multi-dimensional data produced by the flow cytometry machine is then loaded into a computer program for visualization. This visualization aids a human expert in the interpretation of the data. To interpret the data, a human expert will manually separate groups of events (i.e., cells) into different assigned groups. The size of each of the groups of cells is used to produce a human interpretation of the sample. The outcome of the interpretation can drive clinical decision making for physicians treating patients with a hematologic malignancy.

### SUMMARY

Systems and methods are disclosed herein for automatically interpreting flow cytometry data using machine learning by applying gates to the data, and generating a user interface based on that analysis for a user to prepare a final interpretation by manipulating the gates. To this end, a supervised deep model with self-attention and graph layers is trained to classify cells into specific cell types (e.g., lymphocytes, monocytes, etc.) based on flow cytometry data, and gates are drawn around those classifications. The gates are smoothed to ensure that each covers a population of cell types without intersecting with other gates in two dimensional space. A user interface is then generated for a user to manipulate the gates to their satisfaction and draw therefrom a diagnosis. Advantageously, the systems and methods disclosed herein are scalable, as the analysis works to draw gates no matter the number of classifications and to automatically remove intersections between gates, thereby resulting in a many-fold improvement of throughput of flow cytometry analysis.

### BRIEF DESCRIPTION OF THE DRAWINGS

FIG. 1 illustrates one embodiment of a system environment for implementing a cytometry analysis tool.

FIG. 2 illustrates one embodiment of an end-to-end approach for using the systems and methods disclosed herein to diagnose a disease.

FIG. 3 illustrates one embodiment of exemplary modules and databases used by the cytometry analysis tool.

FIG. 4A shows one embodiment an initial gate drawing around cell representations of flow cytometry data.

FIG. 4B shows a vector drawing for finding a close neighbor for use in drawing a next gate during an intersection retreat process.

FIG. 5 shows one embodiment of an updated gate drawing around cell representations of flow cytometry data where the gates have retreated off of intersections.

FIG. 6 illustrates an exemplary process for drawing gates using a machine learning approach.

FIGS. 7A-C illustrate an exemplary user interface for manipulating a gate.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### I. Overview

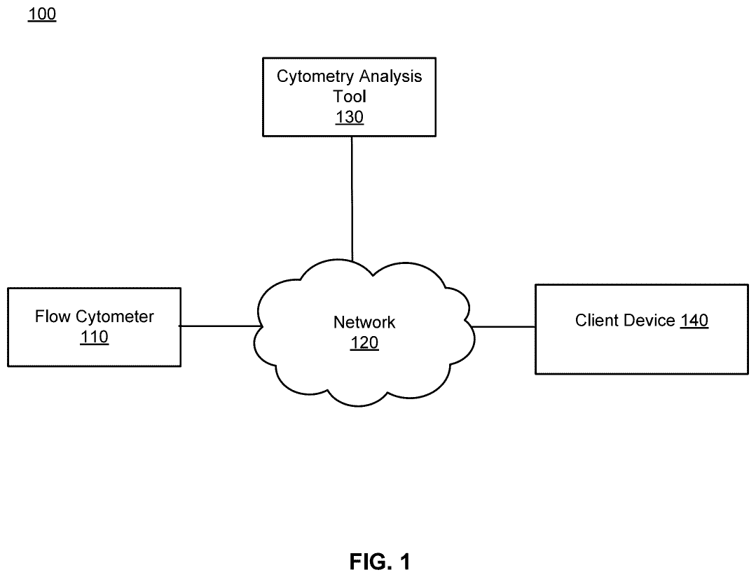

FIG. 1 illustrates one embodiment of a system environment for implementing a cytometry analysis tool. As depicted in FIG. 1, environment 100 includes flow cytometer 110, network 120, cytometry analysis tool 130, and client device 140. While only one instance of each item is depicted, this is for illustrative convenience, and references in the singular to each item is meant to cover instances where plural items exist.

Flow cytometer 110 is a device where a sample (e.g., a biological sample including, but not limited to, blood, bone marrow, cell line or in vitro cell culture, biological fluid, or tissue, such as a solid tumor) is input, and multi-dimensional measurement data is output for each cell in the sample. The multi-dimensional data can be used to measure physical and chemical characteristics of a population of cells or particles. In an exemplary embodiment described herein, the multi-dimensional data is used to detect hematological malignancies.

Network 120 facilitates transmission of data between flow cytometer 110 and cytometry analysis tool 130. Network 120 may be any data conduit, including the Internet, short-range communications, a local area network, wireless communication, cell tower-based communications, or any other communications. Network 120 may also be used to facilitate communications between cytometry analysis tool 130 and client device 140 and/or between flow cytometer 110 and client device 140.

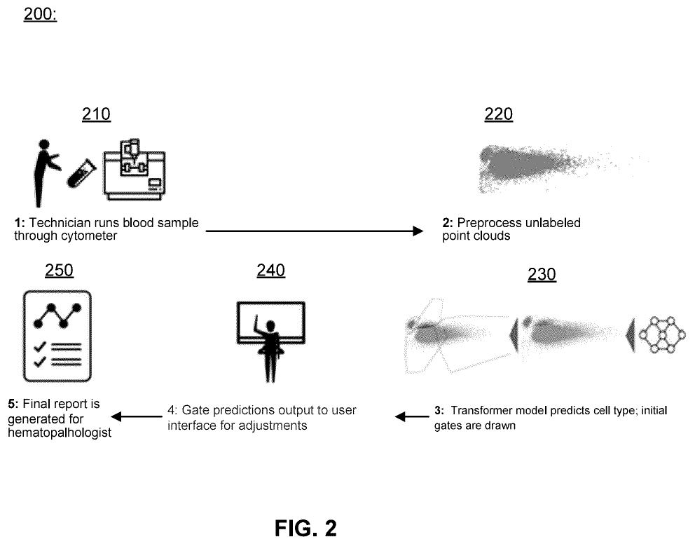

Cytometry analysis tool 130 receives multi-dimensional measurement data from flow cytometer 110. Cytometry analysis tool 130 may be on-premises (e.g., at an academic, clinical or reference laboratory), or may be remote (e.g., in the cloud or at a different location than the aforementioned lab). In an embodiment, cytometry analysis tool 130 may be integrated into flow cytometer 110. Cytometry analysis tool 130 generates gates around cell representations that are derived from the multi-dimensional measurement data and generates a user interface having the gates for display on client device 140, upon which a user may manipulate the gates using the user interface. Further details about cytometry analysis tool 130 and client device 140 are disclosed below with respect to FIGS. 2-5.

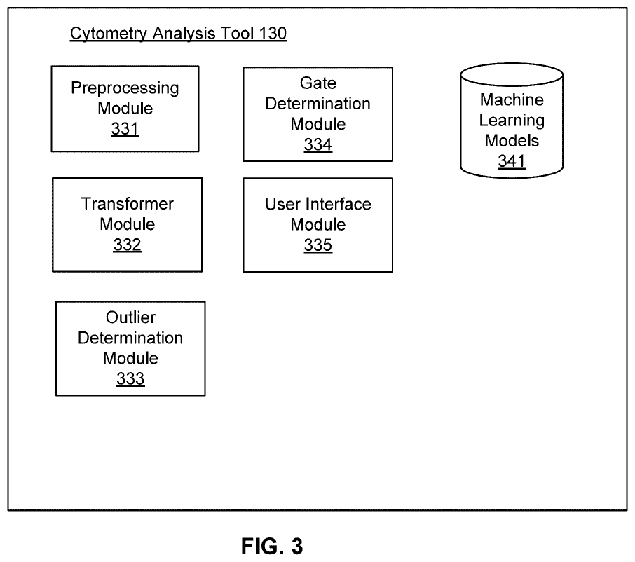

FIG. 2 illustrates one embodiment of an end-to-end approach for using the systems and methods disclosed herein to diagnose a disease. As shown in FIG. 2, process 200 begins with a technician running 210 a sample (e.g., blood or bone marrow sample) through a flow cytometer (e.g., flow cytometer 110). Multi-dimensional data is output by the flow cytometer and transmitted to cytometry analysis tool 130, which may pre-process 220 the data into unlabeled point clouds. Cytometry analysis tool 130 then predicts 230 cell types for each cell represented by the point cloud and draws (and redraws) gates, as will be described below with respect to FIGS. 3-5. Cytometry analysis tool 130 then generates a user interface for display 240 to a user, who may adjust the gates using the user interface, after which a report 250 may be sent to a hematopathologist, or a diagnosis may be output.

FIG. 3 illustrates one embodiment of exemplary modules and databases used by the cytometry analysis tool. As depicted in FIG. 3, cytometry analysis tool 130 includes preprocessing module 331, transformer module 332, outlier determination module 333, gate determination module 334, user interface module 335, and machine learning model database 341. The modules and databases depicted in FIG. 3 are merely exemplary; more or fewer modules and databases may be used to achieve the activity disclosed herein. Moreover, the functionality of cytometry analysis tool 130 may be, in part or in whole, distributed across other devices of environment 100 (e.g., where user interface module 335 or any other module operates in an application installed in client device 140).

Preprocessing module 331 receives multi-dimensional data produced by a flow cytometry machine (e.g., flow cytometer 110) based on a sample (e.g., blood or bone marrow) of a patient. The multi-dimensional data includes cell representations each at a location on a multi-dimensional graph. The cell representations are embeddings that each correspond to a given cell of the sample from the patient. Preprocessing module 331 pre-processes the cell representations using one or more unsupervised machine learning models and, optionally, additional heuristics, to manipulate the cell representations prior to classifying the data for gate drawing. The pre-processing may remove debris that is accidentally included as an event (cell), remove doublets, remove non-nucleated cells, and/or perform any other removal of noise from the multi-dimensional data.

Transformer module 332 takes the pre-processed cell representations and inputs it into a supervised machine learning model. In an embodiment, the supervised machine learning model is a transformer, which is a deep learning architecture that includes self-attention layers, which allow for connections between data points within the model. One preferred embodiment includes both self-attention and graph layers. Such an architecture enables the supervised machine learning model to, when classifying a given cell representation, consider embeddings of other cell representations. In an embodiment, the supervised machine learning model may output binary classifications (e.g., cancerous versus non-cancerous cells). However, in a preferred embodiment, the supervised machine learning model may output more granular cell type classifications (e.g., the cell is a lymphocyte versus a monocyte versus any other cell type). The supervised machine learning model is trained using ground truth preprocessed multi-dimensional data as labeled by its corresponding cell type classification. The trained model may be stored in machine learning model database 341.

In an embodiment, the supervised machine learning model may be trained to perform multi-level classification. That is, a first machine learning model may be used to predict a cell type classification. A second machine learning model may be used to predict a cell type sub-classification. The second machine learning model may be selected from a plurality of candidate sub-classification models, each trained to predict sub-classifications using training data for its corresponding cell type. As an example, a first machine learning model may predict that a cell representation corresponds to a lymphocyte. The second machine learning model may be one trained to predict types of lymphocytes (e.g., CD3 positive, CD4 positive, and so on). By using multi-level classification to predict sub-classifications, model accuracy is improved and model efficiency is improved in that a leaner model is used that does not have noise from training data for other classifications. Moreover, the sub-classification model operates more efficiently than a larger model trained on all sub-classifications, as less processing power is required to predict a classification for a cell representation using a leaner model.

Transformer module 332 receives, as output from the supervised machine learning model, a classification for each cell representation. Practically speaking, cell representations having a same cell type tend to cluster in the graph in terms of location; however, there are outliers and intersections where many cell representations from different cell types are clustered, thus confounding analysis. To this end, gate determination module 334 applies unsupervised machine learning techniques to accurately gate clusters notwithstanding such confounding factors.

Prior to gate determination, outlier determination module 333 determines outlier cell representations within the graph. Outlier determination module 333 performs this determination by identifying cell representations having a given cell type classification that is different in two dimensions from respective cell type classifications of neighboring cell representations. That is, where a given cell type (e.g., lymphocyte) is surrounded on all sides by cell representations having a different cell type (e.g., monocyte), outlier determination module 333 determines that the given cell type is an outlier, and its corresponding cell representation is labeled an outlier.

Gate determination module 334 draws gates based on cell representations that are considered to be “in play” or “active,” and cell representations that are considered to be “out of play,” or “inactive.” How cell representations become classified as “in play” or “out of play” for the purpose of gate determination is described in the next several paragraphs. Other interim classifications are also used and describe in the next several paragraphs. In an embodiment, gate determination module may maintain a data structure that indicates a status of active or inactive for each cell representation.

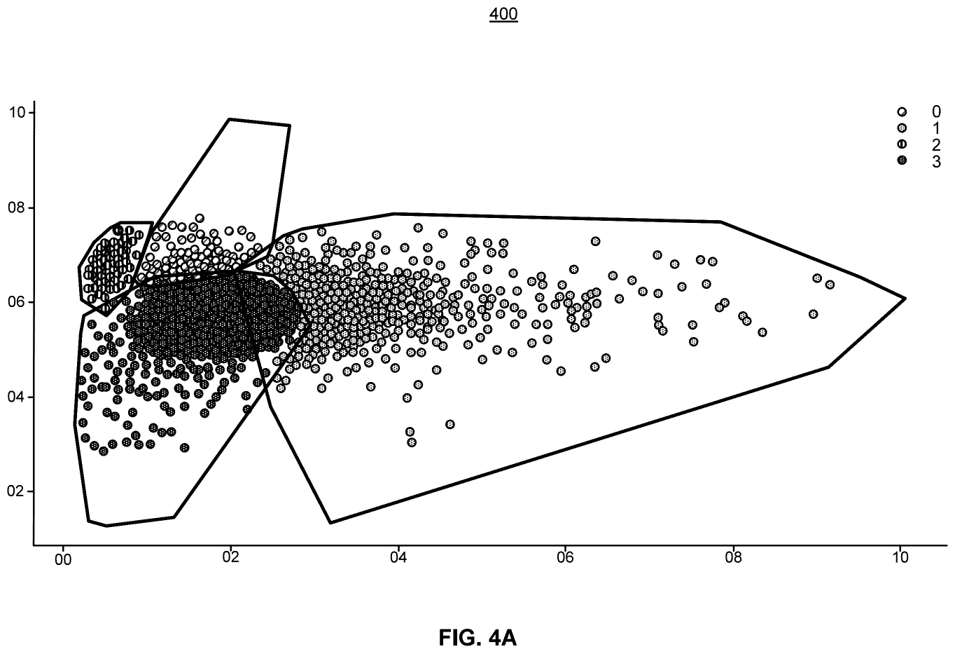

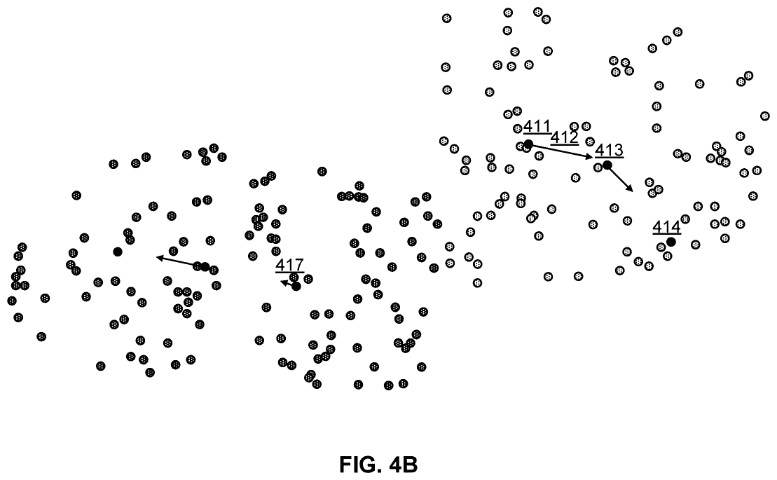

Initially, all cell representations are labeled as active by gate determination module 334. That is, gate determination module 334 may initialize the data structure to show a status of active for all cell representations. After outliers are determined by module 333, gate determination module 334 converts the status of the determined outliers into a status of “inactive” or “out of play,” thus eliminating the outlier cell representations from cell representations that are input into an unsupervised model for gate drawing. The reason for this is that, as can be seen in FIG. 4, populations of cell representations having a same cell type classification tend to cluster. Initially, gates are drawn to include all cell representation of a given type, leading to intersections where cells of two types are intermixed. However, if an outlier exists far from its cluster, then the iterative gate drawing process would consume immense resources and time iterating away from the outlier, and this iterative process would be prone to error. By eliminating outliers at the outset, the intersections are far smaller and far less computing power and processing needs to be performed to eliminate the intersections.

After eliminating the outliers from the active cell representations, gate determination module 334 draws a separate convex hull as a gate around all active cells for each cell type. Turning to FIG. 4, FIG. 4A shows one embodiment an initial gate drawing around cell representations of flow cytometry data. Graph 400 shows convex hulls drawn for four different cell types, as classified by the supervised machine learning model. While depicted using shading, this is for convenience, where shading indicates a dense area of cell representations, and where each convex hull surrounds the outermost cell representations on the graph for each cell type. Different shading grades are used for each cell representation, each shade representing a different cell type. As can be seen, the convex hulls have intersections where cell representations of different types both fit within two or more convex hulls. Gate determination module 334 performs iterative processing using an unsupervised machine learning model to partially or completely eliminate each of the intersections, as follows.

Each hull has its own separate iterative processing. For a given hull, gate determination module 334 marks cell representations that are within the given hull and are not within an intersection with another hull as both “safe” (to be defined momentarily) and “inactive”, thus leaving just the cell representations within an intersection as active. Gate determination module 334 inputs the active cell representations into an unsupervised machine learning model (e.g., retrieved from machine learning models database 341). The machine learning model may be a nearest neighbor module that produces a graph of the nearest k neighbors (k being programmed by a user of cytometry analysis tool 130).

Gate determination module 334 may then determine an average relative vector across the k neighbors for each of the active cells. That is, the vector represents a direction most strongly representative of where cells of the type belonging to the hull belong (e.g., because the density of cell representations having the cell type corresponding to the hull is highest in that direction relative to cell representations having a different cell type). Gate determination module 334 then identifies, relative to a given active cell for which the vector was derived, a closest cell in the direction of the vector. For example, gate determination module 334 may determine a single neighboring cell with maximum cosine similarity with the average vector. The given active cells are then marked as inactive. Gate determination module 334 then receives a concatenation of the “safe” cells as well as the “closest cells”, and uses the concatenation to define for the next iteration of this process the cells that are to start out as “in play” or active, leaving the other cells “inactive” for the next iteration. Note that where a given active cell is pointed to as a “closest cell,” then it would remain as active.

FIG. 4B shows a vector drawing for finding a closest neighbor for use in drawing a next gate during an intersection retreat process. As shown in FIG. 4B, vector 412 corresponds to one cell type, and vector 417 corresponds to another cell type. Both of vectors 412 and 417 are drawn from a given active node based on the K neighbor analysis, and represent a direction that is most strongly representative of where cells of that cell type are. In the case of vector 412, vector 412 is drawn from active cell representation 411. Cell representation 413 is the closest cell representation pointed to by the vector 412, and thus cell representation 413 is marked as the closest cell representation for active cell representation 411. As the process repeats, a vector is drawn from closest cell representation 413 in the same manner, and points to closest cell representation 414, and so on. As this process iterates, it can be seen that the vectors that begin from active cell representations 411 and 417 iteratively retreat toward where the cell populations for each cell type is dense, thus resulting in the corresponding gates retreating accordingly away from the intersection of the two cell types.

The iterative process continues with drawing new convex hulls around each population (e.g., where intersecting areas are now smaller or eliminated), and again inputting the active cells into the machine learning model, and identifying new closest cells, and so on. The iterative process continues until a stopping condition is met. Pausing for context, what the above iterative processing does is iteratively cause the boundaries of each convex hull to retreat away from other convex hulls. That is, because the vectors will generally point inward toward the “safe” cells of a convex hull, as the convex hulls are redrawn in each cycle, the intersections will become smaller.

A stopping condition is any condition that causes the iterative cycle described above to stop. Gate determination module 334 may determine a stopping condition is met based on any conditions programmed by a user of cytometry analysis tool 130. As one example of a stopping condition, gate determination module 334 may monitor for whether there is no longer an intersection between two populations (e.g., counting only “cells in play”), and may determine that for the given hull, a stopping condition has been met. As another example of a stopping condition, gate determination module 334 may determine whether one population accounts for a predefined amount (e.g., 75+%) of the “cells in play” in an intersection, and responsive to making that determination, may determine that a stopping condition has been met. This prevents gate determination module 334 from shrinking the gate for both populations, when the intersecting area can be thought of as more or less “belonging” solely to one population. As yet another example, gate determination module 334 may determine whether there are fewer than a predefined number (e.g., 200) of “cells in play” of either population in a given intersection, meaning the intersection likely cannot be resolved as it represents a concave section of one population, and may responsively determine where this condition exists that a stopping condition has been met.

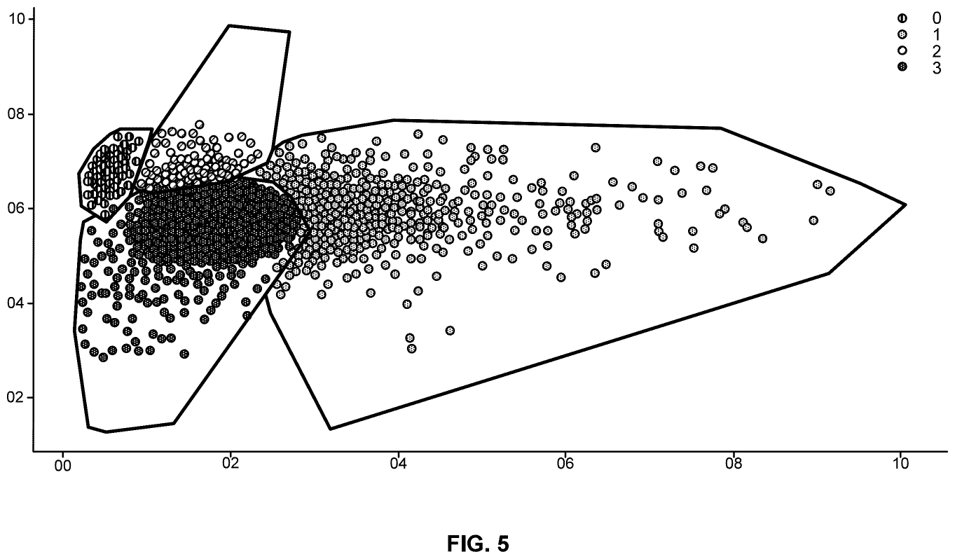

After gate determination module 334 has determined that a stopping condition has been met for all intersecting populations, gate determination module 334 may draw convex hulls around the final “cells in play”. Gate determination module 334 may assign remaining intersecting areas to the population with more “cells in play” within the intersection, and may subtract the intersecting area from the population with fewer cells in play, thereby allowing for concave gates. Gate determination module 334 may then return all final hulls. An example of this can be seen in FIG. 5, where concave hulls are now drawn in based on the post-stopping condition processing. It can be noted that while there a single mathematical convex hull that can be drawn around a group of points in Euclidean space, there is no such single optimal concave hull. This iterative approach thus allows for concave hulls that can effectively mimic human-drawn gates, which often include concave regions.

User interface module 335 generates a user interface for a human operator (e.g., of client device 140) to manipulate the gates. That is, because stopping conditions are used and assumptions are made from that point, the gates may not be completely accurate. However, they are often very close to completely accurate (e.g., 90-97% accurate), thus enabling a human operator to quickly correct any accuracy issues through modifying of the gate (e.g., dragging, adding, or deleting one or more vertices of the polygon gate) before next steps are taken. The next steps may be to provide a report of, or based on, the gates to a doctor. Alternatively, the gates may be input into a machine learning model trained to output a diagnosis therefrom.

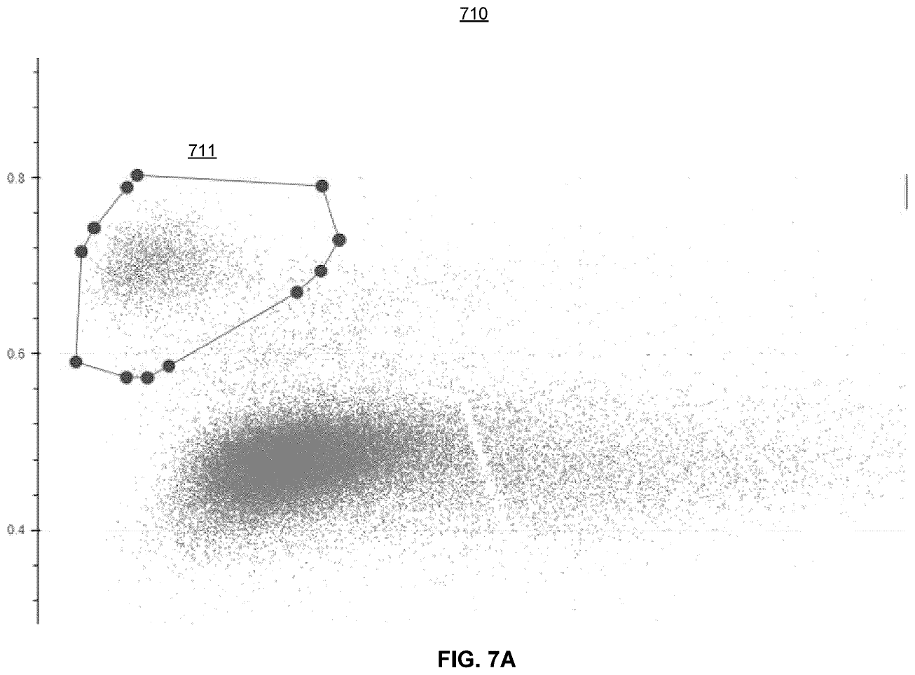

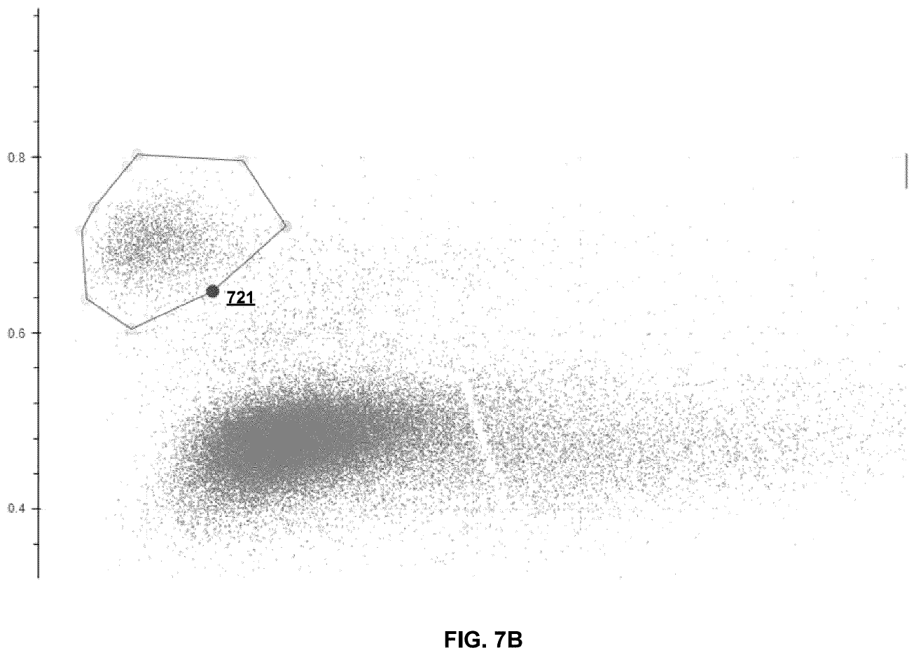

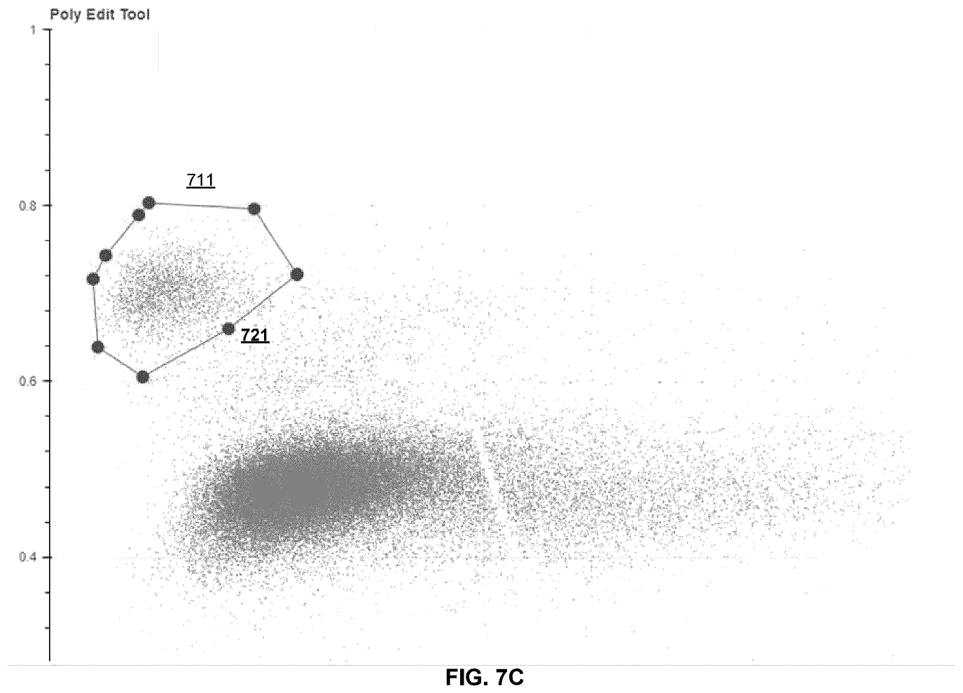

FIGS. 7A-C illustrate an exemplary user interface for manipulating a gate. As shown in FIG. 7A, user interface 710 depicts one or more gates 711, each gate drawn based on determinations described above with respect to FIGS. 3-5. Vertices may be bolded, where each bolded vertex is selectable. FIG. 7B shows vertex 721 has been selected. That is, user interface module 335 detects input from a user commanding to manipulate vertex 721. User interface module 335 may receive directions for how to manipulate vertex 721 by way of detecting a dragging of vertex 721 in a given direction, by way of instructions to move vertex 721 pixel-by-pixel in any given direction, and/or based on any other mode of instruction. FIG. 7C shows, responsive to detecting input to move vertex 721 upward and to the left, gate 711 is adjusted. User input interface 335 may determine that adjustments are complete based on an instruction from the user that gate 711 is finalized. Any number of gates may be manipulated and shown on user interface 710; FIGS. 7A-7C only include one gate for convenience.

In an embodiment, the input from the human operator where gates are redrawn is used to update the training data for the supervised machine learning model that classifies each cell representation. That is, the redrawn gate provides clarity on borderline cell representations that were classified in one manner, but should have been classified in another manner. This information of changed classifications may be used as training data to re-train the supervised machine learning model. Therefore, in subsequent classifications and gate drawings, the gates would be drawn differently and more accurately based on prior usage of the application running the machine learning model, resulting in an improved user interface.

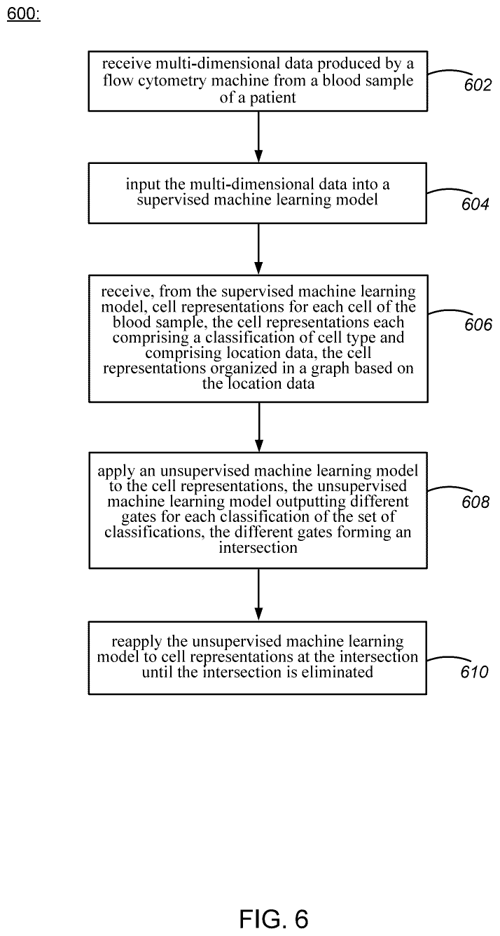

FIG. 6 illustrates an exemplary process for drawing gates using a machine learning approach. Process 600 begins with cytometry analysis tool 130 receiving 602 multi-dimensional data produced by a flow cytometry machine from a sample of a patient (e.g., and pre-processing it using preprocessing module 331). Cytometry analysis tool 130 then inputs 604 the multi-dimensional data into a supervised machine learning model (e.g., using transformer module 332), and receives 606, from the supervised machine learning model, cell representations for each cell of the sample, the cell representations each comprising a classification of cell type and comprising location data, the cell representations organized in a graph based on the location data.

Cytometry analysis tool 130 applies 608 an unsupervised machine learning model to the cell representations (e.g., using gate determination module 334), the unsupervised machine learning model outputting different gates for each classification of the set of classifications, the different gates forming an intersection. Cytometry analysis tool 130 reapplies 610 the unsupervised machine learning model to cell representations at the intersection until the intersection is eliminated.

Beneficially, in one or more embodiments, when applying the transformer model to flow data it is not necessary to specify the number of vertices that a gate should have before drawing the gate. Moreover, embodiments of the invention enable multiple polygons to be analyzed on the same plot and without requiring that the number of polygons be specified beforehand.

In one or more embodiments, the method described herein is performed in a sequential manner to identify progressively more specific subpopulations of cells. For example, when a tube of cells is run through a flow cytometer, depending on how many cell surface markers have been tested for using a different fluorescent color for each marker of interest, there are many individual pieces of information which a single lymphocyte can provide (for example) such as, size and granularity (neither of these require the use of a fluorescent marker since these are physical features which the flow machine measures using light scatter patterns off each cell) and a large number of cell surface markers (e.g., CD3, CD4, CD8, CD45, Ig etc.). Continuing this example, an initial application of the method just plots the information for CD45 expression by the cells and their granularity profile (i.e., how many granules a cell contains). Then, once all of the different populations in this CD45 vs SSC plot are gated, one of the gated populations is selected and the flow cytometer generates the data for two other characteristics for which those cells were also tested (e.g., CD4 expression and CD8 expression). This second round of data may be more straightforward to analyze, so the operator may simply perform an analysis based on a division of the output using four quadrants. However, it is also possible that, rather than applying a quadrant-based analysis, the operator may apply another round of the disclosed method to sort out more complex polygon based populations.

### II. Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A method comprising:
receiving cell representations produced by a flow cytometry machine from a sample of a patient, the cell representations comprising location data and organized in a graph based on the location data, each cell representation corresponding to a cell of the sample;
inputting the cell representations into a supervised machine learning model;
receiving, from the supervised machine learning model, classifications of cell type for each of the cell representations;
applying an unsupervised machine learning model to the classified cell representations, the unsupervised machine learning model outputting different gates for each of the classifications, the different gates forming an intersection; and
reapplying the unsupervised machine learning model to cell representations within the intersection until the intersection is eliminated.

2. The method of claim 1, wherein the supervised machine learning model is a deep learning transformer model that has connections between data points within the supervised machine learning model, thereby enabling the supervised machine learning model to consider embeddings of other cell representations when classifying a given cell representation.

3. The method of claim 2, wherein the supervised machine learning model is trained to predict a cell type from a plurality of candidate cell types.

4. The method of claim 1, further comprising, prior to reapplying the unsupervised machine learning model to the cell representations until the intersection is eliminated:
determining outlier cell representations by identifying given cell representations having a given cell type classification that is different from respective cell type classifications of neighboring cell representations; and
eliminating the outlier cell representations from the cell representations that are input into the unsupervised machine learning model.

5. The method of claim 1, wherein reapplying the unsupervised machine learning model to cell representations at the intersection until the intersection is eliminated further comprises:
initializing a data structure for each of the different gates that tracks each cell representation within each gate as either active or inactive, the initialized data structure marking all cell representations for each gate as active; and
for a given gate:
marking outlier cell representations as inactive;
marking cell representations within the intersection as active; and
marking cell representations outside of the intersection as inactive.

6. The method of claim 5, further comprising:
for each given cell representation in a given gate marked as active, performing an iterative reprocessing comprising:
performing a nearest neighbor search on a predefined number of nearest neighbors of the given cell representation;
generating a vector that points toward a statistical representation of a direction of nearest neighboring cell representations;
identifying a closest neighbor cell to the given cell representation in the direction of the vector;
marking each given cell representation as inactive; and
marking each closest neighbor cell representation as active.

7. The method of claim 6, wherein reapplying the unsupervised machine learning model to cell representations at the intersection until the intersection is eliminated comprises performing the iterative reprocessing until a stopping condition is met.

8. The method of claim 7, further comprising, responsive to determining that the stopping condition is met:
redrawing the different gates around their respective active cell representations;
determining whether any intersections remain;
responsive to determining that any intersections remain, assigning cell representations of the intersection to a given classification corresponding to whichever classification is most prevalent in the active cell representations within the intersection; and
subtracting any intersections from gates corresponding to classifications that are least prevalent in the active cell representations within a given intersection.

9. The method of claim 1, further comprising:
generating for display a user interface comprising the different gates, the user interface enabling an operator to select classifications for any remaining cell representations.

10. The method of claim 1, wherein the sample is a blood sample of the patient.

11. The method of claim 1, wherein the sample is a bone marrow sample of the patient.

12. A non-transitory computer-readable medium comprising memory with instructions encoded thereon that, when executed by one or more processors, causes the one or more processors to perform operations comprising:
receiving cell representations produced by a flow cytometry machine from a sample of a patient, the cell representations comprising location data and organized in a graph based on the location data, each cell representation corresponding to a cell of the sample;
inputting the cell representations into a supervised machine learning model;
receiving, from the supervised machine learning model, classifications of cell type for each of the cell representations;
applying an unsupervised machine learning model to the classified cell representations, the unsupervised machine learning model outputting different gates for each of the classifications, the different gates forming an intersection; and
reapplying the unsupervised machine learning model to cell representations within the intersection until the intersection is eliminated.

13. The non-transitory computer-readable medium of claim 12, wherein the supervised machine learning model is a deep learning transformer model that has connections between data points within the supervised machine learning model, thereby enabling the supervised machine learning model to consider embeddings of other cell representations when classifying a given cell representation.

14. The non-transitory computer-readable medium of claim 13, wherein the supervised machine learning model is trained to predict a cell type from a plurality of candidate cell types.

15. The non-transitory computer-readable medium of claim 12, the operations further comprising, prior to reapplying the unsupervised machine learning model to the cell representations until the intersection is eliminated:
determining outlier cell representations by identifying given cell representations having a given cell type classification that is different from respective cell type classifications of neighboring cell representations; and
eliminating the outlier cell representations from the cell representations that are input into the unsupervised machine learning model.

16. The non-transitory computer-readable medium of claim 12, wherein reapplying the unsupervised machine learning model to cell representations at the intersection until the intersection is eliminated further comprises:
initializing a data structure for each of the different gates that tracks each cell representation within each gate as either active or inactive, the initialized data structure marking all cell representations for each gate as active; and
for a given gate:
marking outlier cell representations as inactive;
marking cell representations within the intersection as active; and
marking cell representations outside of the intersection as inactive.

17. The non-transitory computer-readable medium of claim 16, the operations further comprising:
for each given cell representation in a given gate marked as active, performing an iterative reprocessing comprising:
performing a nearest neighbor search on a predefined number of nearest neighbors of the given cell representation;
generating a vector that points toward a statistical representation of a direction of nearest neighboring cell representations; and
identifying a closest neighbor cell representation to the given cell in the direction of the vector;
marking each given cell representation as inactive; and
marking each closest neighbor cell representation as active.

18. The non-transitory computer-readable medium of claim 17, wherein reapplying the unsupervised machine learning model to cell representations at the intersection until the intersection is eliminated comprises performing the iterative reprocessing until a stopping condition is met.

19. The non-transitory computer-readable medium of claim 18, the operations further comprising, responsive to determining that the stopping condition is met:
redrawing the different gates around their respective active cell representations;
determining whether any intersections remain;
responsive to determining that any intersections remain, assigning cell representations of the intersection to a given classification corresponding to whichever classification is most prevalent in the active cell representations within the intersection; and
subtracting any intersections from gates corresponding to classifications that are least prevalent in the active cell representations within a given intersection.

20-22. (canceled)

23. A system comprising:
memory with instructions encoded thereon; and
one or more processors that, when executing the instructions, are caused to perform operations comprising:
receiving cell representations produced by a flow cytometry machine from a sample of a patient, the cell representations comprising location data and organized in a graph based on the location data, each cell representation corresponding to a cell of the sample;
inputting the cell representations into a supervised machine learning model;
receiving, from the supervised machine learning model, classifications of cell type for each of the cell representations;
applying an unsupervised machine learning model to the classified cell representations, the unsupervised machine learning model outputting different gates for each of the classifications, the different gates forming an intersection; and
reapplying the unsupervised machine learning model to cell representations within the intersection until the intersection is eliminated.

24-33. (canceled)
